(19) United States
(12) Patent Application Publication
(10) Pub. No.: US 2017/0079302 A1
(43) Pub. Date: Mar. 23, 2017

(54) METHOD OF MAKING CHEESE

(71) Applicant: SPX FLOW TECHNOLOGY DANMARK A/S, Silkeborg (DK)

(72) Inventors: Joël LOTODE, Merey (FR); Claus THORSEN, Silkeborg (DK); Ole POULSEN, Engesvang (DK); Jean Claude CORMIER, Kergrist Moelou (FR)

(21) Appl. No.: 15/367,941

(22) Filed: Dec. 2, 2016

Related U.S. Application Data
(63) Continuation-in-part of application No. PCT/EP2015/062235, filed on Jun. 2, 2015.

(30) Foreign Application Priority Data
Jun. 3, 2014 (DK) PA201400298
Aug. 1, 2014 (DK) PA201400431

(51) Int. Cl. A23C 19/02; A23C 19/028

(52) U.S. Cl. CPC A23C 19/02; A23C 19/028

(57) ABSTRACT

A method of making cheese comprising the steps of preparing a paste-like emulsified homogenous pre-cheese mixture, heat treating the pre-cheese mixture of step cooling the pre-cheese mixture of step renneting and filling the pre-cheese mixture of step, characterised in that in step and/or step the pre-cheese mixture is cooled down to a temperature of 41 to 60° C. A related cheese making apparatus, a method of filling and portioning, and pre-cheese mixtures are also disclosed.

### REFERENCE TO RELATED APPLICATIONS

This application claims priority to and is a Continuation-in-part of International Application No. PCT/EP2015/062235, filed Jun. 2, 2015, which claims priority to Danish Application Nos. PA201400298, filed Jun. 3, 2014, and PA201400431, filed Aug. 1, 2014, priority is also claimed to these Danish applications and the disclosures of which are incorporated herein by reference in their entirety.

The present disclosure relates to a method of making cheese.

Also disclosed herein are novel, paste-like, emulsified, homogenous, pre-cheese mixtures which may be used for making traditional ripened cheese as well as soft cheese, and which pre-cheese mixtures are useful for fast and homogenous dispensing or filling.

### INTRODUCTION

A method of making cheese is known from WO 2006/030128 A1. This method is directed to using dairy powders, in particular milk powders, instead of milk for making traditional ripened cheese. The whole disclosure of this publication is incorporated into the present application by reference. The use of dairy powders, in particular milk powders, instead of milk has the advantage that the method is independent of local raw milk availability. Furthermore there is no whey as a by-product of the cheese making. This known method provides a continuous cheese process whereby time and factory floor space is saved during cheese making.

Compared to the traditional cheese making methods, the method known from WO 2006/030128 A1 provides a space saving process line because the known method is running on the basis of cheese concentrate and not on raw milk as traditional methods of making cheese. Also, the energy needed for performing the known method based on dairy powders, in particular milk powders, instead of raw milk is reduced. For instance the pasteurising line capacity needs only to be 1/10 of a traditional cheese milk pasteurising line. It is clear, that the same proportional reduction of energy will be obtained.

Another advantage is that the method is more hygienic and safe because according to the known method the process line can be provided as a closed process line whereas traditional cheese making lines are normally more open. Also the method of this prior art is more simple, because the following equipment may be omitted in a cheese making apparatus: the cheese vat, the cheese whey first drain, the cheese whey second drain, a cutting device for cutting the cheese curd, a device for treating raw milk, and/or cheese pressing equipment.

However the known method has the disadvantage that the obtained pre-cheese mixture is dull grey and unstable to subsequent heat treatment used for pasteurisation or sterilisation.

This disadvantage has been solved by the method as disclosed in WO 2008/151820 A1. The whole disclosure of this publication is incorporated into the present application by reference. The method as disclosed in WO 2008/151820 A1 provides a more attractive white pre-cheese mixture which is stable to pasteurisation or sterilisation without separation.

These known methods are directed to the production of soft and semi-hard cheese without the production of whey as byproduct through the preparation of a cheese base up to 55% TS (total solids) through dissolution of high protein powders and skim-milk powder. After dissolution and pasteurisation, WO 2006/030128 A1 discloses to cool the pre-cheese cheese mixture down to a temperature of less than 40° C. before filling the cheese-base into moulds at that temperature. Filling temperatures in the range of 30 to 40° C. are regularly used in the production of most types of cheeses.

It has been experienced that these low filling temperatures, which are the same as known from filling cheese-base made according to traditional methods, are disadvantageous for the above mentioned methods using dairy powders, and in particular milk powders, instead of milk for making a traditional ripened cheese.

At filling temperatures of about 30 to 40° C. it has been experienced that the cheese curd will start to coagulate as soon as the rennet is added and any stoppage of the continuous flow to the filling system will create lumps of coagulated cheese curd.

When forward flow recommences, these lumps of coagulated cheese will not form a homogeneous cheese with the remaining coagulum with the result that the curd falls apart when subsequently cut, rather like the yolk in a boiled egg. Further problems exist in the fact that the rate of coagulation is fast enough to cause the cheese curd to coagulate to such a viscosity that the top surface of the cheese resembles a dispensed ice cream in a cone.

Accordingly it is an aspect of the disclosure to provide a method for making cheese wherein the above mentioned problems can be avoided. Further, it is an aspect to provide novel, paste-like, emulsified, homogenous, pre-cheese mixtures which may be used for making traditional ripened cheese as well as soft cheese, and which pre-cheese mixtures are useful for fast and homogenous dispensing or filling. Further, it is an aspect of the present disclosure to provide a cheese-making apparatus for executing the methods of the disclosure to provide such desirable novel, paste-like, emulsified, homogenous, pre-cheese mixtures and cheeses therefrom.

This aspect is achieved with the features of the independent claims 1, 16, and 23. Preferred embodiments of the disclosure are disclosed in the dependent claims.

It has surprisingly been discovered that using temperatures for renneting and filling above at least 40° C., from 45° C. to 60° C., and/or of about 45° C., and/or of about 52° C., slows the action of the rennet to a point at which the cheese curd may be filled without any of the homogeneity problems experienced at lower temperatures. The filling can be done by any means of filling including moulding and dosing.

In particular, it has been discovered that using temperatures for renneting and filling above at least 40° C., from 45° C. to 60° C., and/or of about 45° C., and/or of about 52° C., and the use of less thermolabile renneting enzymes and/or less thermnolabile lactic cultures will slow the enzymatic action and decrease the viscosity. As a consequence the cheese curd may be filled without any of the homogeneity problems experienced at lower temperatures. The filling can be done by any means of filling including moulding and dosing.

### BRIEF DESCRIPTION OF THE FIGURES

FIG. 1: Apparatus for executing the experiments of the disclosure.

FIG. 2: Comparative filling results 36-38° C.

FIG. 3: Filling results 52-53° C. according to the disclosure.

### DETAILED DESCRIPTION

According to the disclosure there is provided a method of making cheese comprising the following steps:

(i) preparing a paste-like emulsified homogenous pre-cheese mixture,

(d) heat treating the pre-cheese mixture of step (i),

(e) cooling the pre-cheese mixture of step (d),

(f) renneting and filling the pre-cheese mixture of step (e),

wherein in step (e) and/or step (f) the pre-cheese mixture is cooled down to a temperature of 41 to 60° C.

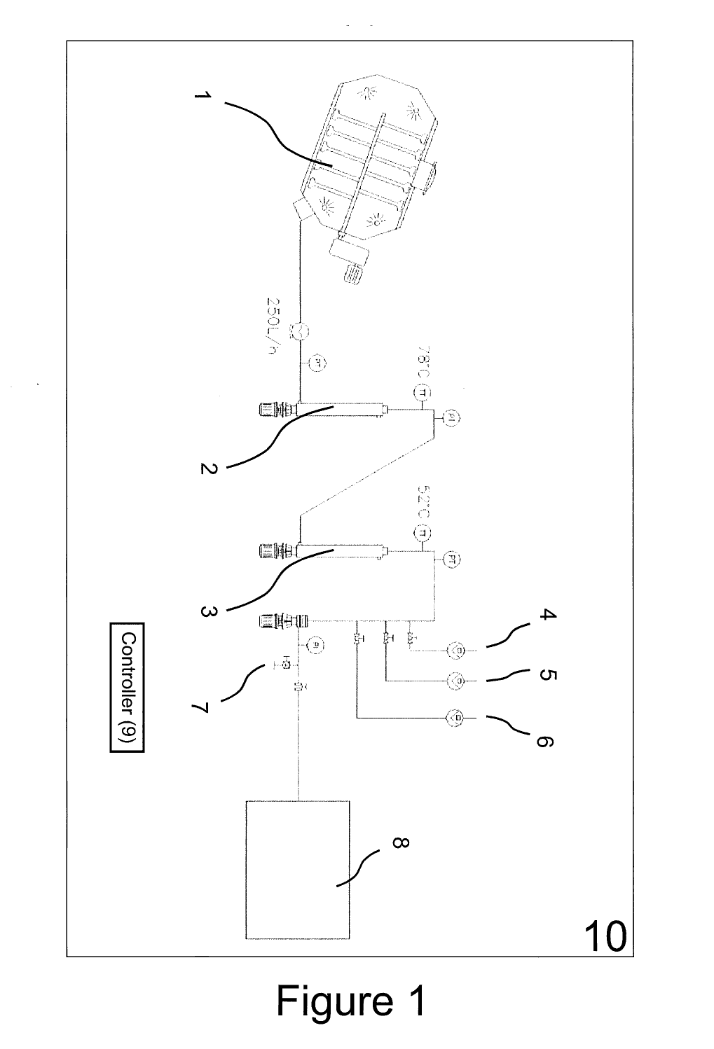

Further the disclosure relates to a cheese making apparatus (10); the cheese making apparatus (10) comprising a processor (1), heating means (2), cooling means (3), at least one dosing pump (4,5,6), and a mixer (7), arranged in sequence as mentioned, and a controller (9) configured for executing a method of making cheese according to the present invention. Details of the cheese making apparatus (10) are further given in FIG. 1.

In accordance with the disclosure in step (e) and/or step (f) the pre-cheese mixture can be cooled down to a temperature of more than 45° C., of more than 48° C., of more than 50° C., and/or to a temperature of about 52° C.

In accordance with the disclosure in step (e) and/or step (f) the pre-cheese mixture is cooled down to a temperature of less than 56° C., of less than 54° C., of less than 53° C., and/or to a temperature of about 52° C.

In particular, the pre-cheese mixture in step (e) and/or step (f) can be cooled to a temperature of between 48° C. to 56° C., from between 50° C. to 54° C., and/or about 52° C.

For making soft cheese the cooling down temperature of step (e) can be more than 40° C., more than 41° C. and more than 43° C. and/or about 45° C.

For making semi-hard cheese or hard cheese the cooling down temperature of step (e) can be higher than for making soft cheese, i.e. in some embodiments, the cooling temperature of step (e) for making semi-hard and hard cheese is about 52° C.

In accordance with the disclosure the paste-like emulsified homogenous pre-cheese mixture of step (i) can be prepared by the following steps:

(a) supplying water, fat, and powders comprising whey protein, milk protein with a controlled lactose content and, optionally, minerals into a processor (1),

(b) emulsifying and homogenising the content of the processor (1),

(c) applying low-pressure or vacuum to the inner space of the processor (1).

The pre-cheese mixture or cheese base can be prepared by using powders, powders comprising protein concentrates. Some embodiments may dry mix the ingredients in the powders prior to preparing the pre-cheese mixture, but it is equally conceivable to mix the necessary ingredients individually in the processor (1). Alternatively and/or in addition concentrated liquids containing high levels of casein produced using icrofiltration/ultrafiltration of milk may be used. Alternatively a cheese-base can be made from liquid concentrates alone. Cheese powder may also be used for providing the cheese-base or pre-cheese mixture.

In accordance with the disclosure step (b) and/or step (c) can be performed until a paste-like emulsified homogenous pre-cheese mixture is obtained.

In accordance with the disclosure step (b) and/or step (c) can be performed at a temperature between 40° C. and 65° C. In some embodiments, the temperature is between 45° C. and 64° C., between 50° C. and 63° C., between 55° C. and 62° C., between 58° C. and 61° C., and/or about 60° C.

In accordance with the disclosure step (b) and/or step (c) can be performed at a shear rate of more than about 5, 000/sec, at a shear rate of more than about 7, 500/sec, and/or at a shear rate of about 10,000/sec.

In accordance with the disclosure step (b) and/or step (c) can be are performed at a shear rate of less than about 40, 000/sec, at a shear rate of less than about 20, 000/sec, and/or at a shear rate of about 10, 000/sec.

In accordance with the disclosure step (b) and/or step (c) can be performed until a phase conversion of the content of the processor (1) takes place.

In accordance with the disclosure in step (b) and/or step (c) the temperature can be raised until a phase conversion of the content of the processor (1) takes place.

In accordance with the disclosure step (b) and/or step (c) can be performed until an increase of the viscosity of the contents of the processor (1) is detected and/or the colour of the contents of the processor (1) turns white.

This provides the advantage, that a very stable pre-cheese mixture is obtained. The results are obtained by applying a temperature of about 57° C. to 63° C., and/or of about 60° C., and high shear rates of at least 5,000/sec. Surprisingly it has been discovered that no phase separation takes place even in case high temperature treatments are made thereafter, like sterilisation etc.

It has been noted that a phase conversion may take place at a temperature of about 60° C., especially when a high shear rate, for instance of about 10,000/sec is applied. After the phase conversion has taken place the temperature can stay on its temperature or raised to a higher temperature without risking a phase separation.

If the phase conversion takes place, the viscosity of the pre-cheese mixture increases dramatically. The increased viscosity can be easily detected. For instance a higher energy demand of the processor (1) is due to the increased viscosity. Therefore, the increased viscosity of the contents of the processor (1) and the higher energy demand is an indication that a phase conversion has taken place.

In accordance with the present disclosure in step (b) the temperature can be increased to the temperature of step (b) after an initial mixing has taken place.

In accordance with the present disclosure step (b) and/or step (c) can be performed for at least 10 minutes, for at least 15 minutes, for at least 20 minutes, and/or for about 30 minutes.

In accordance with the present disclosure step (b) and/or step (c) can be performed until the cheese base turns white and there is a marked increase in viscosity, as evidenced by an increase in power consumption of the processor (1).

In accordance with the present disclosure step (b) and/or step (c) can be performed for less than about 60 Minutes, less than about 45 Minutes and/or for about 30 Minutes.

In accordance with the present disclosure in step (c) the vacuum can be applied to the head space of the processor (1) with the powder being introduced below the level of the liquid in the processor (1). This prevents powder being sucked out by the vacuum.

In accordance with the present disclosure in step (c) a low-pressure or vacuum of less than about 2 mbar, less than about 1 mbar and/or of about 0.5 mbar can be applied.

In accordance with the present disclosure step (b) and step (c) are performed at least partially simultaneously, simultaneously or one after the other.

In accordance with the present disclosure the paste-like emulsified homogenous pre-cheese mixture can be pasteurised. The pasteurisation can be performed in step (b) and/or step (c) and thereafter. If the pasteurisation is performed in step (b), the temperature is raised to a first temperature, for instance 60° C., until the phase conversion takes place, and thereafter raised to a second temperature, for instance 74° C., where the pasteurisation takes place.

In the cheese production the milk is pasteurised, i.e. heated instantaneously to 68-74° C. to kill bacteria that can destroy the cheese quality otherwise without affecting the ability of the casein to coagulate.

During pasteurisation, vegetative bacteria are killed. However the spores of the bacteria are heat resistant and will not be killed by the temperatures pasteurisation is performed at. Butyric acid bacteria and other types of such bacteria can be detrimental for the fermentation of cheese. Accordingly it will be advantageous to eliminate the spores also from the pre-cheese mixture. For milk this is normally made by means of a mechanical separation or through the use of a membrane process described as microfiltration. Due to the higher density of spores it is possible to eliminate the spores from the milk using a centrifuge. However this separation method cannot be performed with the pasty-like pre-cheese mixture because of its high viscosity. Similarly, the use of microfiltration is not possible.

In accordance with the disclosure the pre-cheese mixture can be sterilised and/or pasteurised.

In accordance with the present disclosure the pre-cheese mixture can be heated in step (d) at a temperature of more than about 120° C., more than about 130° C., and/or at a temperature of about 140° C.

In accordance with the present disclosure the pre-cheese mixture can be sterilised in step (d) for more than about 1 second, for more than about 2 seconds, and/or for about 3 seconds.

In accordance with the present disclosure the pre-cheese mixture can be sterilised in step (d) for than less 5 seconds, for less than about 4 seconds, and/or for about 3 seconds.

In accordance with the present disclosure in step (d) steam infusion heating can be used for heating of the pre-cheese mixture.

In accordance with the present disclosure in step (d) the pre-cheese mixture can be preheated to a first heat treatment temperature and then heated to the final heat treatment temperature.

In accordance with the present disclosure the final heat treatment temperature can be a temperature of more than about 120° C., more than about 130° C., and/or a temperature of about 140° C.

In accordance with the present disclosure the first heat treatment temperature can be a temperature of more than 75° C., more than 80° C. and/or of about 85° C.

In accordance with the present disclosure the first heat treatment temperature can be a temperature of less than 95° C., less than 90° C. and/or of about 85° C.

In accordance with the present disclosure in step (d) the pre-cheese mixture can be preheated by means of a surface heat exchanger (2), such as, for example, by means of a scraped surface heat exchanger.

In accordance with the present disclosure in step (d) the pre-cheese mixture can be heated to the final heat treatment temperature by means of steam infusion heating. This has the advantage, that despite the high temperatures a gentle heat treatment can be performed because the intended temperature can be achieved in a very short time.

It has been surprisingly discovered that due to this gentle heat treatment by means of steam infusion; a sterilisation of the pre-cheese mixture can be obtained and that the sterilised pre-cheese mixture can be used to make a traditionally ripened cheese with a better microbiological cheese quality.

In accordance with the present disclosure in step (e) the pre-cheese mixture can be cooled by means of a heat exchanger (3), such as by means of a scraped surface heat exchanger or flash cooled by means of the vacuum vessel of an infusion plant.

In accordance with the present disclosure in step (e) the pre-cheese mixture can be cooled to a first cooling temperature and then cooled to a final cooling temperature.

In accordance with the present disclosure the first cooling temperature can be a temperature of more than 75° C., more than 80° C. and/or of about 85° C.

In accordance with the present disclosure the first cooling temperature is a temperature of less than 95° C., less than 90° C. and/or of about 85° C.

In accordance with the present disclosure in step (e) the pre-cheese mixture can be cooled down to the first cooling temperature by means of flash cooling, such as by means of a flash vessel operated under vacuum.

In accordance with the present disclosure in step (e) the pre-cheese mixture can be cooled down to the final cooling temperature by means of a heat exchanger (3), such as by means of a scraped surface heat exchanger.

In accordance with the present disclosure production aids can be added to the pre-cheese mixture after step (d) and/or after step (e) and/or in step (f).

It is well known in the art of making cheese that without production aids cheeses will not be produced from cheese-bases or pre-cheese mixtures in known methods of making cheese.

An example of a production aid is a cheese starter culture. Since the temperature in step (f) is higher than by the known methods for making cheese, many known cheese starter cultures will be destroyed if added after step (f) to the pre-cheese mixture. To provide the necessary acidification of the cheese; mesophilic and thermophilic starter cultures, such as e.g. Hansen Lactic Acid A2010 Culture or Hansen DVS LHBO1 Culture, obtainable from Chr. Hansen of Hørsholm, Denmark, can be used in accordance with the disclosure. Alternatively, or in addition to the use of cheese starter cultures, the addition of glucono delta lactone is possible to produce the required acidity in the cheese.

In accordance with the present disclosure the production aids can comprise acidifying agents, fermenting agents and/or coagulating enzymes. As according to the disclosure these production aids are added at temperatures which would normally impede the ability of production aids used in known methods of making cheese from causing the transformation of a cheese-base or pre-cheese mixture into a cheese, all production aids contemplated in the present disclosure are those, wherein the ability for causing the transformation of a cheese-base or pre-cheese mixture into a cheese is not affected by the increased mixing temperatures contemplated in the present disclosure.

In accordance with the present disclosure the production aids can comprise acids, preferably glucono delta lactone.

In accordance with the present disclosure the production aids can comprise mesophilic fermenting agents and/or thermophilic fermenting agents, such as of the genus of Lactobacillus and/or Streptococcus, such as e.g. Hansen Lactic Acid A2010 Culture or Hansen DVS LHBO1 Culture (Lactobacillus helveticus) obtainable form Chr. Hansen of Hørsholm, Denmark.

In accordance with the present disclosure the production aids comprise a coagulating agent such as bovine or microbial rennet, mesophilic and/or thermophilic coagulating agents, mesophilic and/or thermophilic bovine or microbial rennet enzymes, e.g. such as mucorpepsin of Rhizomucor miehei obtainable from Chr. Hansen of Hørsholm, Denmark (e.g. Hansen Hannilase L 205 or Hansen Hannilase XL 205 microbial rennet enzymes).

In accordance with the present disclosure, adding production aids can be stopped before a break in the mixing process. If stopped, the mixing may be stopped at least for the period of time it takes the paste-like emulsified homogenous pre-cheese mixture to pass from the portion of the mixer (7) where the production aids are added to the exit of the mixer (7). This provides the additional advantage that no coagulation of the pre-cheese mixture will take place in the mixer (7); because all pre-cheese mixture comprising production aids has been removed from the cheese making apparatus (10).

In accordance with the present disclosure the paste-like emulsified homogenous pre-cheese mixture exiting the mixer (7) can be recirculated into the processor (1) of step (a) if the method is to be continued after a break, it may be recirculated at least for the period of time it takes the paste-like emulsified homogenous pre-cheese mixture to pass from the portion of the mixer (7) where the production aids are added to the exit of the mixer (7). This provides the advantage that the pre-cheese mixture exiting the cheese making apparatus (10) but not having production aids added can be reused and does not have to be discharged.

Accordingly, there is disclosed according to the present disclosure a paste-like emulsified homogenous pre-cheese mixture comprising production aids, wherein said production aids have been added to said paste-like emulsified homogenous pre-cheese mixture at a temperature above 41° C.; and which paste-like emulsified homogenous pre-cheese mixture has a viscosity below 12.000 cp.

Further there is disclosed a paste-like emulsified homogenous pre-cheese mixture comprising production aids, wherein said pre-cheese mixture is prepared according to a method of any of the methods of the current disclosure; or wherein said pre-cheese mixture comprising production aids is a pre-cheese mixture comprising production aids according to the previous paragraph and wherein said pre-cheese mixture is prepared according to a method of any of the methods of the current disclosure.

In accordance with the present disclosure cheese can be produced using the pre-cheese mixture of step (f).

In accordance with the present disclosure step producing the cheese can include moulding, incubation, pressing, salting, ripening, removing the cheese from the mould, or other steps known from the traditional way of making cheese.

In accordance with the present disclosure the paste-like emulsified homogenous pre-cheese mixture can have a dry matter content of up to 65% by weight, from 40 to 55% by weight, and/or from 42 to 52% by weight.

In accordance with the present disclosure the paste-like emulsified homogenous pre-cheese mixture can comprise butyric acid fat, cream and/or vegetable fat.

In accordance with the present disclosure the powders comprising whey protein concentrate and milk protein concentrate with reduced lactose content can have a lactose content of less than about 10% by weight.

In accordance with the present disclosure the powders comprising whey protein concentrate and milk protein concentrate with reduced lactose content can have a native, non-denatured protein content of more than about 65% by weight.

In accordance with the present disclosure the powders comprising whey protein concentrate and milk protein concentrate with reduced lactose content can, when mixed, have a resultant casein content of more than about 80% of total solids by proteins, and/or between 85 and 92% of total solids by proteins.

In accordance with the present disclosure the powders comprising whey protein concentrate and milk protein concentrate with reduced lactose content and/or the pastelike emulsified homogenous pre-cheese mixture can have a casein to whey protein ratio of at least 85:15, of at least 90:10 and/or of about 98:2 and/or a casein to whey protein ratio corresponding to that of traditional cheese.

In accordance with the present disclosure the total solid content of the paste-like emulsified homogenous pre-cheese mixture can be at least 40%, at least 50% and/or about 55%.

In accordance with the present disclosure the total solid content of the paste-like emulsified homogenous pre-cheese mixture after flash cooling using an infusion plant can be about 65.

The disclosure also relates to a cheese making apparatus (10); the cheese making apparatus (10) comprising a processor (1), heating means (2), cooling means (3), at least one dosing pump (4,5,6), and a mixer (7), arranged in sequence as mentioned, and a controller (9) configured for executing a method of making cheese according to the present disclosure.

The processor (1) is a solid-liquid mixer; for example, the processor (1) is a solid-liquid mixer comprising a high shear rate impeller. Said, mixer (7) may be an in-line mixer.

In a further embodiment, the cheese making apparatus comprises a filling machine (8) arranged after said mixer (7).

In accordance with the disclosure the cheese making apparatus (10) can further comprise heating means (2), wherein the heating means can include a steam infusion heating device, and/or a heat exchanger, such as a scraped surface heat exchanger.

In accordance with the disclosure there is further provided a cheese making apparatus (10) comprising a processor (1) and sterilisation means. In another and further embodiment, said heating means (2) comprises sterilization means. In accordance with the present disclosure the sterilisation means can comprise a steam infusion heating device. In one embodiment, the heating means (2) comprises first heating means, such as a heat exchanger, for example, a scraped surface heat exchanger and second heating means or sterilization means, such as a steam infusion heating device.

In accordance with the disclosure the cheese making apparatus (10) comprises cooling means (3), wherein the cooling means can include a heat exchanger, such as a scraped surface heat exchanger (3). In one embodiment, the cooling means (3) comprises first cooling means, such as flash cooling means, such as a flash vessel operated under vacuum, and second cooling means, such as a heat exchanger, such as a scraped surface heat exchanger.

Other characteristics and advantages will become clear from the following detailed description of exemplary embodiments in accordance with the disclosure.

When the processor (1) is a solid-liquid mixer, the solid-liquid mixer used can be any mixer capable of mixing solids with liquids at the desired temperature and shear rate. For instance the FLEX-MIX PROCESSOR of SPX Flow Technology may be used, with a high shear rate impeller installed. The solid-liquid mixer chosen should have sufficient power in order to provide a shear rate of at least 5,000/sec, or of at least 10,000/sec. There may be vacuum means for applying low pressure or vacuum at the head space of the solid-liquid mixer.

The cheese making apparatus (10) may include a mixer (7), such as an in-line mixer (7), connected after the processor (1). For instance the DAR mixer of SPX Flow Technology may be used. At least one dosing pump (4,5,6) is provided for dosing production aids (for instance rennet and starter) into the pre-cheese paste entering into the mixer (7). The mixer (7) is provided for thoroughly mixing the production aids into the pre-cheese mixture.

) If pasteurisation of the pre-cheese mixture is desired, for instance a scraped surface heat (2) exchanger may be used, being connected between the processor (1) and the in-line mixer.

If sterilisation of the pre-cheese mixture is desired, for instance an infusion heating device, in combination with a heat exchanger (2), for instance a scraped heat exchanger may be used, being connected between the processor (1) and the mixer (7).

The pre-cheese mixture exiting the mixer (7) comprises dry matter content of 40 to 65% by weight, of 50 to 60% by weight, and/or of 52% by weight.

The casein to whey protein ratio of the pre-cheese mixture corresponds to the casein to whey protein ratio of the final cheese. Clearly, it is intended that the casein to whey protein ratio shall be the similar or slightly lower as for traditional cheese.

From the exit of the mixer (7) the pre-cheese mixture is filled into moulds, using at least one filling machine (8) connected after the mixer (7), and treated as traditional cheese with the exception that no mechanical pressing is required. The skilled person is aware of these techniques.

As production aids coagulation enzymes (for instance rennet) lactic starters and/or a chemical acidulant such as glucono delta lactone may be added.

The sterilisation and/or heat treatment step may be carried out at a minimum temperature of 130° C., for instance for at least 3 seconds, or may utilise an equivalent treatment.

The pre-cheese mixture exiting the mixer (7) will normally have a high viscosity, such that the pre-cheese mixture can directly be moulded into moulds or receptacles normally used by the skilled person for further treatment such as ripening etc. Ideally, the viscosity of the pre-cheese mixture does not exceed 12.000 cP. In some embodiments, the viscosity of the pre-cheese mixture ranges from 1.000 cP to 12.000 cP, from 2.000 cP to 11.000 cP, from 3.000 cP to 10.000 cP, from 4.000 cP to 9.000 cP, from 5.000 cP to 8.000 cP, or from 6.000 cP to 7.000 cP.

In the moulds the pre-cheese mixture will coagulate because of the added production aids such as rennet.

To complete the coagulation and acidification, an incubation step is following the step of moulding the pre-cheese mixture. During this step the cheeses are in their moulds and incubation takes place at a temperature of 28 to 45° C. and a hygrometry rate of 95 to 100% for a period of time which can vary from a few hours to 20 hours, until a pH is obtained in the order of 5.3 to 4.8.

In accordance with the disclosure it will be possible to mould and directly portion cheeses in any desired shape and/or size. This technology enables a wide variety of unusual cheese shapes to be obtained owing to the removal of mechanical pressing. Accordingly, the present disclosure also relates to a method of filling and directly portioning a pre-cheese mixture of the present disclosure into a mould of a desired shape using conventional methods of filling or using the cheese making apparatus (10) of the disclosure at a temperature above 41° C., at a temperature between 41° C. and 60° C., at a temperature of about 45° C. or at a temperature of about 52° C.

After the incubation step has been completed, the cheeses are removed from the moulds and further steps may be performed of which the skilled person is aware, for instance salting (in brine or using dry salt) and/or any treatments for obtaining rinds and/or special flavours etc.

If desired, other standard cheese-making techniques may be performed that the skilled person is aware of.

The cheese obtained in accordance with the method and/or apparatus of the disclosure are almost identical to traditionally produced cheeses. However the cheeses are obtained by using dairy powder, such as milk powder, instead of raw milk. Accordingly the production of cheese is very easy. Especially there is no need of remove any by-products as is necessary in the traditional methods for producing cheese.

In principle any variety of semi-hard or hard cheese analogues can be produced with the method and/or apparatus of the present disclosure.

It is clear that the description of the specific embodiments of the invention is not to be intended to limit the scope of protection which is defined by the claims. It is also clear that obvious alternatives which the skilled person will notice by reading the specification are intended to be in the scope of protection as defined by the claims.

Accordingly the disclosure also relates to a method for the production of soft and semi-hard cheese in which high protein powders and/or liquid high protein concentrates are prepared at up to 55% total solids followed by heat treatment at pasteurisation or UHT temperatures to destroy bacteria. After heat treatment the cheese-base is cooled to a temperature of 40-55° C. and/or 52° C. before adding rennet and either mesophilic and/or thermophilic starter culture or glucono delta lactone. The resulting cheese curd is filled into containers either through moulding or dosing equipment.

### EXAMPLES

For running the examples in accordance with the disclosure the following materials have been used:

### Ingredia Promilk SH15

### Skim Milk Powder

CORMAN MGLA Classic butter oil

### Hansen Hannilase L205 Enzyme

### Hansen Hannilase XL 205 Enzyme

Hansen Lactic acid A2010 Culture

### Hansen DVS LHB01 Culture

### Salinor Salt

An apparatus as shown in FIG. 1 has been set up for running the examples.

Brine solution 6 was prepared following the formulation in the respective recipe by adding salt to sterilized distilled water and mixed with steel agitator.

Starter culture 4 was prepared just before running the example following the formulation in the respective recipe by adding the cultures to the sterilized distilled water and mixed with steel agitator.

Coagulating enzyme (rennet) 5 was prepared just before running the example following the formulation in the recipe by adding rennet to sterilized distilled water and mixed.

Butter oil according to formulation was melted in a water bath at 65-68° C. and added to the water in processor (1), followed by mixing of water and butter.

After mixing of the water and butter oil, the milk powder was slowly added to processor (1) by vacuum suction below level. The water, butter oil and milk powder were then high shear mixed until a phase change occurred or the requested temperature was reached.

The mix was then pumped through scraped surface heat exchanger (2) with a flow of 250 kg/h, where the temperature was raised to 78-80° C. with a holding time of 30 seconds. After the holding cell the mix was cooled in scraped surface heat exchanger (3) to a temperature of between 41° C. to 60° C., in particular of about 52° C., followed by addition of starter culture, brine and enzyme solution by dosing pumps (4,5,6) just before the mixer (7) (A Darmix Mixer).

The cheese mix was then transferred to the filling machine (8) (A Nova Filling Machine) and filled into cups or buckets at temperatures between 41° C. and 60° C. Excess material was transferred into waste container.

The filled cups and buckets were stored over night at 32-33° C. for acidification and afterwards stored in cold store at 7° C.

The cheeses were moved in cold chain to a maturing cellar for final ripening.

The processor (1) used may be a Flex-Mix™ Processor. The Flex-Mix™ Processor is a highly efficient batch processing unit, developed to handle demanding mixing applications including high viscous liquids, emulsification and additional particulates.

For instance batch production of 250, 500, 1000, 2000 or 3000 litres are possible. Typical capacities per hour are up to 20,000 litres depending on product complexity.

The Flex-Mix™ Processor is an inclined tank with a bottom mounted high shear mixer. This mixer partly functions as an axial agitator and/or partly as an in-line mixer. It creates an axial flow, which is re-circulated in the tank by means of the surrounding mixer chamber and/or a positive booster pump, which is used to bypass and re-circulate the flow over the tank. The bypass flow is returned into the tank and the inclined tank ensures that no liquid rotation (forced vortex) will be created in the tank.

The tank is also equipped with a slow rotating agitator ensuring a careful stirring and homogeneous mixing of particulated products simultaneously with the creation of an axial flow, which feeds the bottom impeller. When mounted with scraper blades, the agitator ensures that the product does not burn and stick to the tank wall during indirect heating (tank with cooling/heating jacket). In case the product is heated, the tank can be put under pressure. By means of vacuum, powder is transported into the tank through a special powder inlet valve.

The mixture of powder/air is led directly into the liquid below the liquid surface. Air/gas is removed by the vacuum pump. The large free liquid surface gives an effective de-aeration of the product, unlike traditional mixing that generally incorporate air during mixing. This will help to reduce oxidation, improve product quality and consistency. Addition of powders or other dry matter can also take place through the manway placed in the top of the tank. Processors (1) complying with the above specifications of the Flex-Mix™ Processor are specifically used in the method of the disclosure, but other suitable processors may naturally be used instead.

### Example 1

The following recipe has been used for a total batch weight of 200 kg:

| Water (kg) | | 89.8 |
|---|---|---|
| SH15 (kg) | | 48.8 |
| Butter oil (kg) | | 45.6 |
| Skim-milk powder (kg) | | 0 |
| Sol. Salt | salt (kg) | 2.6 |
| (brine) | water (kg) | 10.4 |
| Sol. Enzyme | enzyme (ml) | 10 |
| (rennet) | water (kg) | 0.8 |
| Sol Culture | A-2010 (g) | 400 |
| (starter) | LHB01 (g) | 200 |
| | water (kg) | 2 |

The mixing in the Flex-Mix™ Processor (1) went as expected, and a phase conversion was obtained.

The mix was heated to 78° C. and cooled to 52-53° C. in the scraped surface heat exchangers (2,3). The culture, rennet and brine were added and mixed in by the mixer (7). The final product was homogenous.

The filling in the Nova machine (8) was working as expected. The filling temperature was about 52° C. and the resulting viscosity was below 12.000 cP as expected. Cheeses were produced. They acidified overnight, and were transferred to cold storage the following morning with a pH1 of 5.2. The structure of the cheeses produced were good, with only very few and small air bubbles.

### Example 2

The following recipe has been used for a total batch weight of 262 kg:

| Water (kg) | | 124.25 |
|---|---|---|
| SH15 (kg) | | 61 |
| Butter oil (kg) | | 57 |
| Skim-milk powder (kg) | | 0 |
| Sol. Salt | salt (kg) | 3.25 |
| (brine) | water (kg) | 13 |
| Sol. Enzyme | enzyme (ml) | 12.5 |
| (rennet) | water (kg) | 1 |
| Sol Culture | A-2010 (g) | 500 |
| (starter) | LHB01 (g) | 250 |
| | water (kg) | 2.5 |

The mixing in the Flex-Mix™ Processor (1) went as expected, and a phase conversion was obtained.

The mix was heated to 78° C. and cooled to 52-53° C. in the scraped surface heat exchangers (2,3). The culture, rennet and brine were added and mixed in by the mixer (7). The final product was homogenous.

The filling in the Nova machine (8) was working as expected. The filling temperature was about 52° C. and the resulting viscosity was below 12.000 cP as expected. Cheeses were produced. They acidified overnight and were transferred to cold storage the following morning with a pH of 5.2. The structure of the cheeses produced were good, with only very few and small air bubbles.

### Example 3

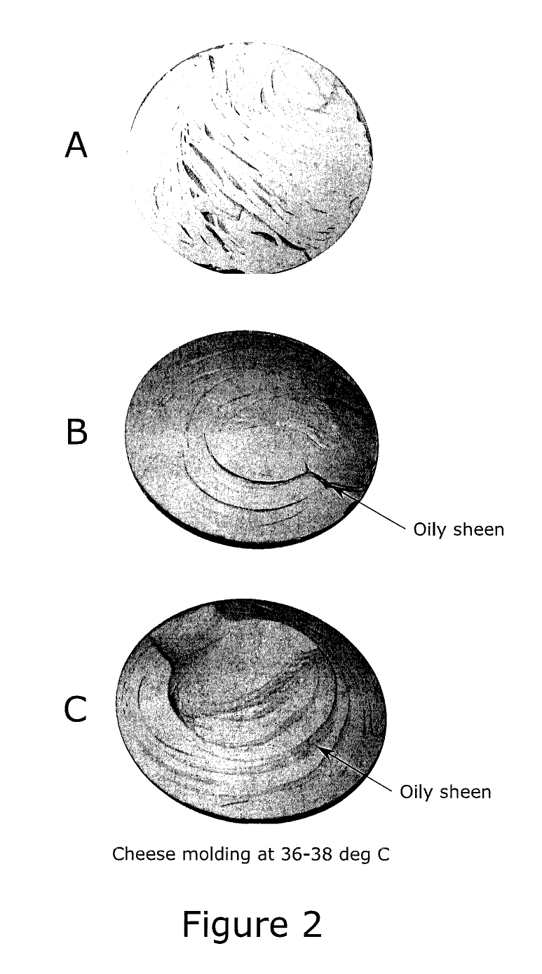

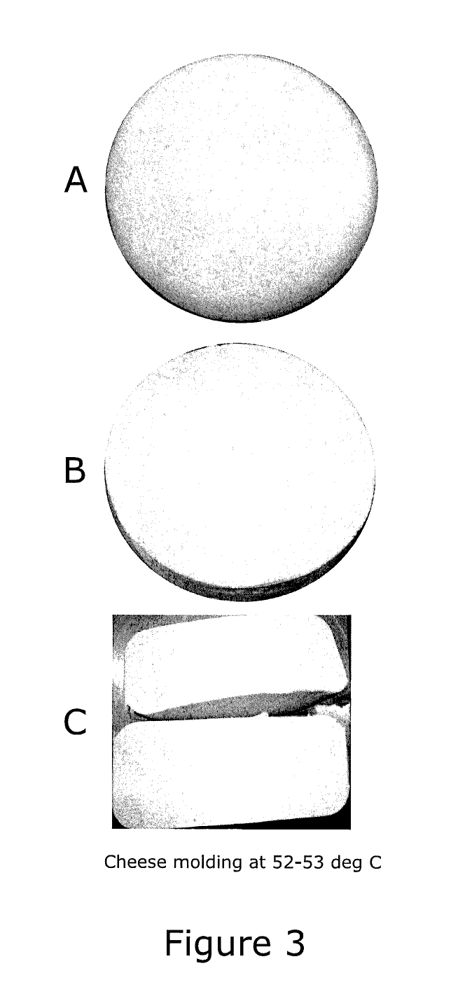

FIGS. 2 and 3 show exemplary photos documenting the outcome of filling a respective cheese mould with a pre-cheese mixture as according to example 1 of the present disclosure in a comparative experiment at 36-38° C. (FIG. 2) and a respective cheese mould at 52-53° C. according to the disclosure (FIG. 3).

As discussed above it has been experienced that at filling temperatures of about 30 to 40° C. the cheese curd will start to coagulate as soon as the rennet is added and any stoppage of the continuous flow to the filling system will create lumps of coagulated cheese curd. When forward flow recommences, these lumps of coagulated cheese will not form a homogeneous cheese with the remaining coagulum with the result that the curd falls apart when subsequently cut, rather like the yolk in a boiled egg. Further problems exist in the fact that the rate of coagulation is fast enough to cause the cheese curd to coagulate to such a viscosity that the top surface of the cheese resembles a dispensed ice cream in a cone.

These unwanted effects of the prior art cheese filling processes are clearly visible in FIGS. 2A-C, wherein through-cuts of a moulded cheese prepared at 36-38° C. in accordance with the prior art is shown. The direction of the cut FIG. 2-A is at 90° to the direction of the cuts in FIGS. 2-B and 2-C. FIG. 2A clearly depicts the yolk-like structure of the moulded cheese. FIG. 2B depicts how the filling process (rotating filler head) generates an internal cheese structure reflecting the filling process, whereby in FIG. 2C it is documented how the moulded cheese is prone to low coherence between the yolk-like layers. Particularly displeasing, albeit difficult to discern in the b/w-renderings is that the cheese colour is a skin-like pinkish colour, not associated with cheese, with regions (see arrows) of an oilish, yellowish sheen.

The cheeses filled according to the present disclosure are shown in the photos of FIGS. 3A-C. FIG. 3A shows the outer cheese surface after filling of the cheese mould, which is almost completely without structure, and in particular without traces of the filling procedure. FIG. 3B shows a through-cut of the cheese of FIG. 3A along a first line and FIG. 3C shows a through-cut of the cheese of FIG. 3A at 90° to the through-cut of FIG. 3B. No internal structures or lack of internal coherence in the cheese are visible in the cheese prepared according to the present invention. Further, the cheeses of the present invention (not visible in b/w) have a cheese-yellow like colour as expected by consumers.

### CLOSING COMMENTS

The term “comprising” as used in the claims does not exclude other elements or steps. The term “a” or “an” as used in the claims does not exclude a plurality.

Although embodiments in accordance with the present invention has been described in detail for purpose of illustration, it is understood that such detail is solely for that purpose, and variations can be made therein by those skilled in the art without departing from the scope of the invention.

1. A method of making cheese comprising the following steps:
(i) preparing a paste-like emulsified homogenous pre-cheese mixture,
(d) heat treating the pre-cheese mixture of step (i),
(e) cooling the pre-cheese mixture of step (d),
(f) renneting and filling the pre-cheese mixture of step (e),
cooling down the pre-cheese mixture to a temperature of 41 to 60° C. in either step (e) or step (f).

2. The method according to claim 1, wherein the pre-cheese mixture is cooled down to a temperature of one of the following temperatures: more than 45° C., more than 48° C., more than 50° C., and about 52° C.

3. The method according to claim 1, wherein the pre-cheese mixture is cooled down to a temperature of one of the following temperatures: less than 56° C., less than 55° C., less than 54° C., less than 53° C., and a temperature of about 52° C.

4. The method according to claim 1, wherein the paste-like emulsified homogenous pre-cheese mixture of step (i) is prepared by the following steps:
(a) supplying water, fat and powders comprising whey protein concentrates and milk protein with a controlled lactose content concentrates into a processor,
(b) emulsifying and homogenising the content of the processor,
(c) applying low-pressure or vacuum to the inner space of the processor,
wherein at least one of: step (b) and step (c) are performed until a paste-like emulsified homogenous pre-cheese mixture is obtained.

5. The method according to claim 4, wherein at least one of the following steps (1, 2, or 3) occur:
(1) at least one of: step (b) and step (c) are performed until a phase conversion of the content of the processor takes place,
(2) at least one of: step (b) and step (c) the temperature is raised until a phase conversion of the content of the processor takes place, and
(3) at least one of: step (b) and step (c) are performed until an increase of the viscosity of the contents of the processor is detected and/or the colour of the contents of the processor turns white.

6. The method according to claim 4, wherein at least one of the following steps (1, 2, or 3) is performed:
(1) step (b) and step (c) are performed at a temperature between 60° C. and 65° C.,
(2) in step (b) the temperature is increased to the temperature of step (b) after an initial mixing has taken place, and
(3) the paste-like emulsified homogenous pre-cheese mixture is pasteurised.

7. The method according to claim 4, wherein at least one of the following steps (1 and 2) are performed:
(1) at least one of: step (b) and step (c) are performed at one or more of the following shear rates: more than about 5,000/sec, more than about 7, 500/sec, and about 10,000/sec, and
(2) at least one of: step (b) and step (c) are performed at one of more of the following a shear rates: less than about 40, 000/sec, less than about 20,000/sec, and about 10,000/sec.

8. The method according to claim 4, wherein at least one of the following steps (1-6) occur:
(1) at least one of: step (b) and step (c) are performed for any one of the following time periods: at least 10 minutes, at least 15 minutes, at least 20 minutes and about 30 minutes,
(2) at least one of: step (b) and step (c) are performed until the cheese base turns white and there is a marked increase in viscosity, as evidenced by an increase in power consumption of the processor,
(3) at least one of: step (b) and step (c) are performed for any one of the following time periods: less than about 60 Minutes, less than about 45 Minutes and for about 30 Minutes,
(4) in step (c) the vacuum is applied to the head space of the processor with the powder being introduced below the level of the liquid in the processor,
(5) in step (c) a low-pressure or vacuum of any one of the following pressure is applied: less than about 2 mbar, less than about 1 mbar and about 0.5 mbar, and
(6) steps (b) and (c) are performed at least partially simultaneously, simultaneously or one after the other.

9. The method according to claim 1, where in step (d) the pre-cheese mixture is at least one of: sterilised and pasteurised.

10. The method according to claim 1, where one or more of the following steps (1-5) occurs: in step (d)
(1) the pre-cheese mixture is heated at a temperature of at least one of the following temperatures: more than about 120° C., more than about 130° C., and at a temperature of about 140° C.,
(2) the pre-cheese mixture is sterilised for at least one of the following time periods: more than about 1 second, for more than about 2 seconds, and for about 3 seconds,
(3) the pre-cheese mixture is sterilised for at least one of the following time periods: than less 5 seconds, less than about 4 seconds, and for about 3 seconds,
(4) steam infusion heating is used for heating of the paste-like emulsified homogenous pre-cheese mixture, and
(5) the paste-like emulsified homogenous pre-cheese mixture is preheated to a first heat treatment temperature and then heated to a final heat treatment temperature.

11. The method according to claim 10, wherein any one of the following steps (1-5) occur:
(1) the final heat treatment temperature is any one of the following temperatures: more than about 120° C., more than about 130° C., and a temperature of about 140° C.,
(2) the first heat treatment temperature any one of the following temperatures: more than 75° C., more than 80° C. and of about 85° C.,
(3) the first heat treatment temperature is any one of the following temperatures: less than 95° C., less than 90° C. and about 85° C.,
(4) in step (d) the pre-cheese mixture is preheated by means of either a surface heat exchanger, and a scraped surface heat exchanger, and
(5) in step (d) the paste-like emulsified homogenous pre-cheese mixture is heated to the final heat treatment temperature by means of steam infusion heating.

12. The method according to claim 1, wherein at least one of the following steps (1-2) occur:
(1) in step (e) the pre-cheese mixture is cooled by any one of the following ways: by means of a heat exchanger, by means of a scraped surface heat exchanger and flash cooled by means of the vacuum vessel of an infusion plant, and
(2) in step (e) the paste-like emulsified homogenous pre-cheese mixture is cooled to a first cooling temperature and then cooled to a final cooling temperature.

13. The method according to claim 12, wherein any one of the following steps (1-4) occur:
(1) the first cooling temperature is any one of the following temperatures: a temperature of more than 75° C., more than 80° C. and about 85° C.,
(2) the first cooling temperature is any one of the following temperatures: a temperature of less than 95° C., less than 90° C. and about 85° C.,
(3) in step (e) the heat treated paste-like emulsified homogenous pre-cheese mixture is cooled down by any of the following ways: to the first cooling temperature by means of flash cooling, by means of a flash vessel operated under vacuum, and
(4) in step (e) the pre-cheese mixture is cooled down to the final cooling temperature by any one of the following: by means of a heat exchanger, and by means of a scraped surface heat exchanger.

14. The method according to claim 1, wherein production aids are added to the pre-cheese mixture in or after steps (d), (e) or (f),
wherein the production aids comprise any one of the following: acidifying agents, fermenting agents and coagulating enzymes,
acids, glucono delta lactone,
mesophilic fermenting agents, thermophilic fermenting agents, thermophilic fermenting agents of the genus of Lactobacillus and/or Streptococcus,
a coagulating agent, bovine or microbial rennet; and
wherein adding production aids is stopped before a break, at least for the period of time it takes the paste-like emulsified homogenous pre-cheese mixture to pass from a portion of a mixer where the production aids are added to an exit of said mixer, wherein the paste-like emulsified homogenous pre-cheese mixture exiting said mixer is recirculated into the processor of step (a) if the method is to be continued after a break, recirculated at least for the period of time it takes the paste-like emulsified homogenous pre-cheese mixture to pass from a portion of said mixer where the production aids are added to an exit of said mixer.

15. The method according to claim 1, wherein cheese is produced using the paste-like emulsified homogenous pre-cheese mixture of step (f), by moulding, incubation, pressing, salting, ripening, removing the cheese from the mould or other steps known from the traditional way of making cheese,
the pre-cheese mixture has a dry matter content of any one of the following ranges: 40 to 65% by weight and 42-52% by weight,
the pre-cheese mixture comprises at least one of: butyric acid fat, cream and vegetable fat,
the powders comprising whey protein concentrate and milk protein concentrate with reduced lactose content have a lactose content of less than about 10% by weight,
the powders comprising whey protein concentrate and milk protein concentrate with reduced lactose content have a native, non-denatured protein content of more than about 65% by weight,
the powders comprising whey protein concentrate and milk protein concentrate with reduced lactose content have when mixed a resultant casein content of any one of the following ranges: more than about 80% of total solids by proteins, between 85 and 92% of total solids by proteins,
the powders comprising whey protein concentrate and milk protein concentrate with reduced lactose content and the paste-like emulsified homogenous pre-cheese mixture have a casein to whey protein ratio of any one of the following ranges: at least 85:15, at least 90:10 and about 92:8 and a casein to whey protein ratio corresponding to that of traditional cheese,
the total solid content of the paste-like emulsified homogenous pre-cheese mixture is at any one of the following percentages: least 40%, at least 50% and about 55%, and
the total solid content of the paste-like emulsified homogenous pre-cheese mixture after flash cooling using an infusion plant is about 65%.

16. A cheese making apparatus; the cheese making apparatus comprising a processor, heating means, cooling means, at least one dosing pump, and a mixer, arranged in sequence as mentioned, and a controller configured for executing a method of making cheese according to claim 1.

17. The cheese making apparatus of claim 16 wherein said processor comprises a solid-liquid mixer or a solid-liquid mixer comprising a high shear rate impeller.

18. The cheese making apparatus of claim 16 comprising a filling machine arranged after said mixer.

19. The cheese making apparatus according to claim 16, wherein said heating means can comprise a steam infusion heating device, and/or a heat exchanger, preferably a scraped surface heat exchanger.

20. The cheese making apparatus according to claim 19, wherein said heating means comprises sterilization means and said heating means comprises a first heating means, and at least one of either: second a heating means and sterilization means.

21. The cheese making apparatus according to claim 16, wherein said cooling means includes any one of the following: a heat exchanger, a scraped surface heat exchanger and a flash vessel operated under vacuum.

22. The cheese making apparatus according to claim 21, wherein said cooling means comprises first cooling means and second cooling means.

23. A paste-like emulsified homogenous pre-cheese mixture comprising production aids, wherein said production aids have been added to said pre-cheese mixture at any one of the following temperatures: a temperature above 41° C., and between 41° C. to 60° C.; and which paste-like emulsified homogenous pre-cheese mixture has a viscosity at any one of the following viscosities: below 12.000 cP, and above 1.000 cP to below 12.000 cP.

24. A paste-like emulsified homogenous pre-cheese mixture comprising production aids, wherein said pre-cheese mixture is prepared according to a method of claim 1;
or wherein said pre-cheese mixture comprising production aids is a pre-cheese mixture comprising production aids wherein said production aids have been added to said pre-cheese mixture at any one of the following temperatures: a temperature above 41° C., and between 41° C. to 60° C.; and which paste-like emulsified homogenous pre-cheese mixture has a viscosity at any one of the following viscosities: below 12.000 cP, and above 1.000 cP to below 12.000 cP.

25. A method of filling and directly portioning a pastelike emulsified homogenous pre-cheese mixture comprising production aids, said pre-cheese mixture being according to claim 23, using a filling machine operated at a temperature in any one of the following ranges: above 41° C., between 41° C. and 60° C., about 45° C. and about 52° C.
